(19) United States
(12) Patent Application Publication
(10) Pub. No.: US 2007/0070437 A1
(43) Pub. Date: Mar. 29, 2007

(54) Method for incising a sheet of media

(75) Inventors: Adam J. Ahne, Lexington, KY (US); Randy A. O'Neal, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/236,032

(22) Filed: Sep. 27, 2005

(51) Int. Cl. H04N 1/40

(52) U.S. Cl. 358/448

(57) ABSTRACT

A method for incising a sheet of media includes defining an incising margin boundary for the sheet of media, the incising margin boundary defining a minimum distance from each of at least one of the plurality of edges of the sheet of media that an incising may be made; determining a current location with respect to the sheet of media where an image is to be printed; determining an image incising boundary for the image; determining whether the image incising boundary for the image at the current location is located completely within the incising margin boundary for the sheet of media; and if the image incising boundary is not located completely within the incising margin boundary, then relocating the image such that the image incising boundary is located completely within the incising margin boundary.

### BACKGROUND OF THE INVENTION

1. Field of the Invention

The present invention relates to an imaging apparatus, and, more particularly, to a method for incising a sheet of media.

2. Description of the Related Art

A typical imaging apparatus, such as a printer or an All-In-One machine (AIO), includes a print engine for forming an image on one or more sheets of print media, such as paper. Such a print engine may be, for example, an ink jet print engine having a reciprocating printhead carrier, or an electrophotographic (e.g., laser) print engine. An AIO is a multifunction unit that is configured to perform stand alone functions, such as copying or facsimile receipt and transmission, or may be connected to a host computer via a communications link to facilitate a printing function.

Some imaging apparatus may be used in conjunction with a perforator unit that is used to perforate or cut a sheet of media, such as paper. However, the perforator unit typically cannot make acceptable perforations near the edges of the sheet of media. For example, the top edge of the sheet of media may be cantilevered, and accordingly, the sheet of media will deflect during perforation, resulting in perforation failure in that region. The same problem may occur at the bottom edge.

### SUMMARY OF THE INVENTION

The invention, in one form thereof, is directed to a method for incising a sheet of media having a plurality of edges. The method includes defining an incising margin boundary for the sheet of media, the incising margin boundary defining a minimum distance from each of at least one of the plurality of edges of the sheet of media that an incising may be made; determining a current location with respect to the sheet of media where an image is to be printed; determining an image incising boundary for the image; determining whether the image incising boundary for the image at the current location is located completely within the incising margin boundary for the sheet of media; and if the image incising boundary is not located completely within the incising margin boundary, then relocating the image such that the image incising boundary is located completely within the incising margin boundary.

The invention, in another form thereof, is directed to an imaging apparatus, including a printing unit for performing printing operations and an incising unit for performing incising operations. A controller is communicatively coupled to the printing unit and the incising unit. The controller executes program instructions to perform the acts of: defining an incising margin boundary for the sheet of media, the incising margin boundary defining a minimum distance from each of at least one of the plurality of edges of the sheet of media that an incising may be made; determining a current location with respect to the sheet of media where an image is to be printed; determining an image incising boundary for the image; determining whether the image incising boundary for the image at the current location is located completely within the incising margin boundary for the sheet of media; and if the image incising boundary is not located completely within the incising margin boundary, then relocating the image such that the image incising boundary is located completely within the incising margin boundary.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of a system implementing the present invention.

FIG. 2 is a diagrammatic representation of an imaging apparatus configured for use in implementing the present invention.

FIG. 3 is a flowchart of an exemplary method in accordance with the present invention.

FIG. 4 is a diagrammatic representation of an incising margin boundary defined for the sheet of media, with an exemplary image having an image incising boundary outside the incising margin boundary.

FIG. 5 is a diagrammatic representation of the incising margin boundary defined for the sheet of media as in FIG. 4, but with the image relocated such that the image incising boundary associated with the image is within the incising margin boundary.

Corresponding reference characters indicate corresponding parts throughout the several views. The exemplifications set out herein illustrate one or more embodiments of the invention, and such exemplifications are not to be construed as limiting the scope of the invention in any manner.

### DETAILED DESCRIPTION OF THE INVENTION

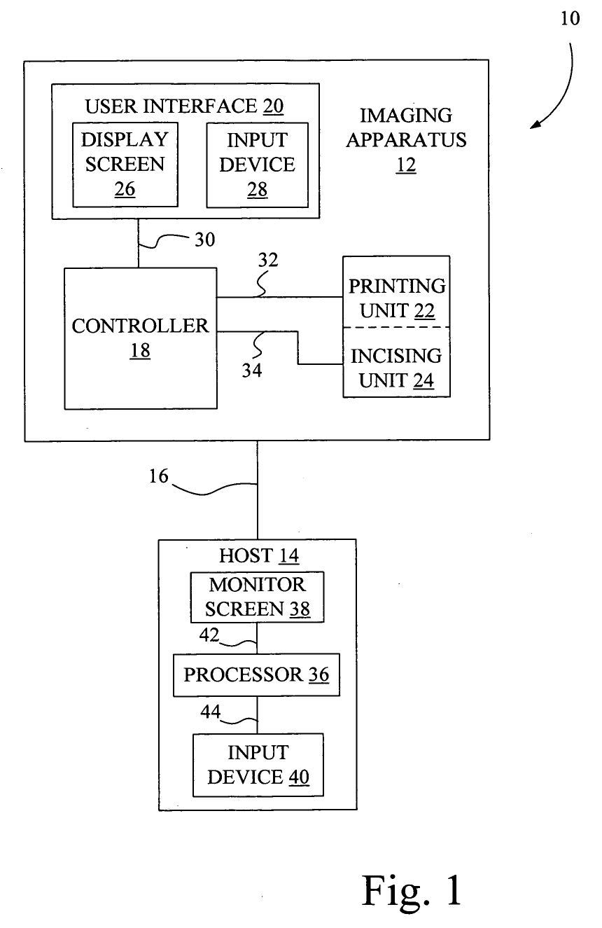

Referring now to the drawings and particularly to FIG. 1, there is shown a system 10 embodying the present invention. System 10 includes an imaging apparatus 12, and optionally, a host 14.

Imaging apparatus 12 may be, for example, a printer, such as an ink jet printer, which in turn may form the print engine for an AIO machine, such as for example, a standalone unit that has scanning, copying, and/or faxing functionality, in addition to printing functionality. Host 14, which may be optional, may be communicatively coupled to imaging apparatus 12 via a communications link 16.

As used herein, the term “communications link” generally refers to structure that facilitates electronic communication between two components, and may operate using wired or wireless technology. Accordingly, communications link 16 may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

In the embodiment of FIG. 1, imaging apparatus 12 includes a controller 18, a user interface 20, a printing unit 22 and an incising unit 24. User interface 20 includes a display screen 26 and an input device 28, such as a keypad. Controller 18 is communicatively coupled to user interface 20 via a communications link 30. Controller 18 is communicatively coupled to printing unit 22 via a communications link 32. Controller 18 is communicatively coupled to incising unit 24 via a communications link 34.

Printing unit 22 may be, for example, an ink jet printer having a reciprocating printhead carrier, or other suitable print engine for forming an image on a substrate, such as a sheet of paper.

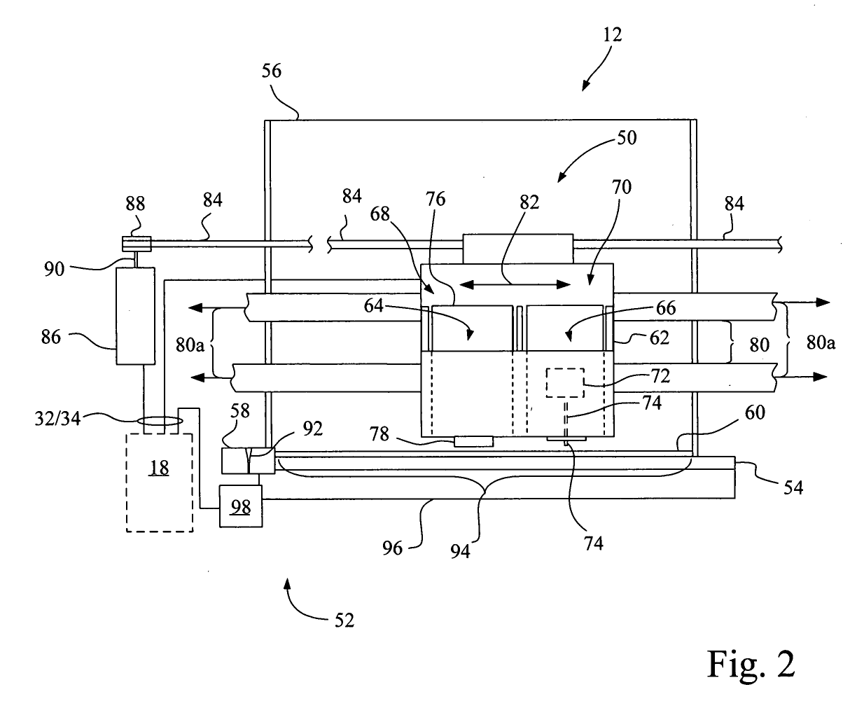

Incising unit 24 may include, for example, an incising device and/or a cutting device. One example of an incising device, which can also be used for cutting, includes a reciprocating needle assembly, and is described in further detail below with respect to FIG. 2. Known cutting devices include, for example, rotary cutters and knife cutters.

In some embodiments of imaging apparatus 12, such as for example where imaging apparatus 12 is an AIO, controller 18 may include in its memory a software or firmware program including program instructions that function as a driver for printing unit 22 and/or incising unit 24, and will be referred to herein as a driver program. The driver program, for example, may include a halftoning unit and a data formatter subroutine that places print data and print commands in a format that can be recognized by printing unit 22, and may include an incising driver subroutine for placing incising and/or cutting instructions or data in a format that can be recognized by incising unit 24. The driver program may be accessed, for example, by a software application, such as for example, a photo processing application, a greeting card making application, etc., that is executing on imaging apparatus 12.

With the present invention, it is advantageous in some embodiments for incising unit 24 to be combined with printing unit 22 in a single imaging apparatus, as shown in FIGS. 1 and 2. However, those skilled in the art will recognize that the principles of the present invention may be achieved in systems where incising unit 24 is independent from printing unit 22.

In embodiments including host 14, host 14 may be, for example, a personal computer including a processor 36, a monitor screen 38 and an input device (e.g., keyboard) 40, and further includes such devices as input/output (I/O) interfaces, memory, such as RAM, ROM, NVRAM, and a mass data storage device, such as a hard drive, CD-ROM and/or DVD units. Processor 36 is communicatively coupled to monitor screen 38 via communications link 42. Processor 36 is communicatively coupled to input device 40 via communications link 44. Further, processor 36 is communicatively coupled to controller 18 of imaging apparatus 12 via communication link 16.

During a printing/incising operation, host 14 may include in its memory the driver program including program instructions that function as a driver for imaging apparatus 12. The driver program, for example, may include a halftoning unit and a data formatter subroutine that places print data and print commands in a format that can be recognized by printing unit 22, and may include an incising driver subroutine for placing incising and/or cutting instructions or data in a format that can be recognized by incising unit 24. The driver program may be accessed, for example, by a software application, such as for example, a word processing application, a greeting card making application, etc., that is executing on host 14.

FIG. 2 is one exemplary embodiment of imaging apparatus 12, including printing unit 22 and incising unit 24, which may be used in conjunction with the present invention.

Printing unit 22 and incising unit 24 collectively include, for example, a carrier system 50, a feed roller unit 52, a mid-frame 54, a media source 56, and an incising maintenance station 58.

Media source 56 is configured and arranged to supply from a stack of media a sheet of media 60 to feed roller unit 52, which in turn further transports the sheet of media 60 during a printing operation and/or an incising operation.

Carrier system 50 includes a carrier 62, i.e., carriage, that is configured with one or more bays, for example bay 64 and bay 66. Each of bays 64, 66 is mechanically and electrically configured to mount, carry and facilitate one or more types of printhead cartridges 68, such as a monochrome printhead cartridge and/or a color printhead cartridge, and/or a perforator cartridge 70 that includes a perforation mechanism 72 driving a perforation device 74, such as a needle or blade, in a reciprocating manner.

Each printhead cartridge 68 includes an ink reservoir 76 provided in fluid communication with a printhead 78, which may include multiple ink jet nozzle arrays. Multiple printheads may be included on printhead cartridge 68. Perforator cartridge 70 is sized and configured to be mechanically and electrically compatible with the configuration of the printhead cartridges 68 so as to be interchangeable therewith in carrier 62 in one of bays 64 and 66.

Carrier 62 is guided by a pair of guide members 80. Either, or both, of guide members 80 may be, for example, a guide rod, or a guide tab formed integral with the imaging apparatus frame. The axes 80a of guide members 80 define a bi-directional scanning path 82 of carrier 62. Carrier 62 is connected to a carrier transport belt 84 that is driven by a carrier motor 86 via a carrier pulley 88. In this manner, carrier motor 86 is drivably coupled to carrier 62 via carrier transport belt 84, although one skilled in the art will recognize that other drive coupling arrangements could be substituted for the example given, such as for example, a worm gear drive. Carrier motor 86 can be, for example, a direct current motor or a stepper motor. Carrier motor 86 has a rotating motor shaft 90 that is attached to carrier pulley 88. Carrier motor 86 is coupled, e.g., electrically connected, to controller 18 via communications link 32.

Incising maintenance station 58 includes an abrasive member 92, such as a ceramic material, arranged to receive and sharpen perforation device 74, such as for example, a needle or a blade.

At a directive of controller 18, carrier 62 is transported in a controlled manner along bi-directional scanning path 82, via the rotation of carrier pulley 88 imparted by carrier motor 86. During printing, controller 18 controls the movement of carrier 62 so as to cause carrier 62 to move in a controlled reciprocating manner, back and forth along guide members 80. In order to conduct perforator maintenance operations, e.g., sharpening, controller 18 controls the movement of carrier 62 to position carrier 62 in relation to incising maintenance station 58. Printhead 78 is electrically connected to controller 18 via communications link 32. Perforation mechanism 72 is electrically connected to controller 18 via communications link 34.

During a printing/incising operation, the reciprocation of carrier 62 transports printhead 78 and perforation mechanism 72 across the sheet of media 60 along bi-directional scanning path 82, i.e., a scanning direction, to define a print/incising zone 94 of imaging apparatus 12. Bi-directional scanning path 82 is parallel with axes 80a of guide members 80, and is also commonly known as the horizontal direction. Controller 18 supplies electrical address and control signals to the ink jetting actuators of printhead 78 to effect the selective ejection of ink from printhead 78. Further controller 18 supplies control signals to perforation mechanism 72 to effect the selective actuation of perforation mechanism 72 for performing perforating or cutting operations using perforation device 74. During each scan of carrier 62, the sheet of media 60 is held stationary by feed roller unit 52. Feed roller unit 52 includes a feed roller 96 and a drive unit 98. The sheet of media 60 is transported through print/incising zone 94 by the rotation of feed roller 96 of feed roller unit 52. A rotation of feed roller 96 is effected by drive unit 98. Drive unit 98 is electrically connected to controller 18 via communications link 32.

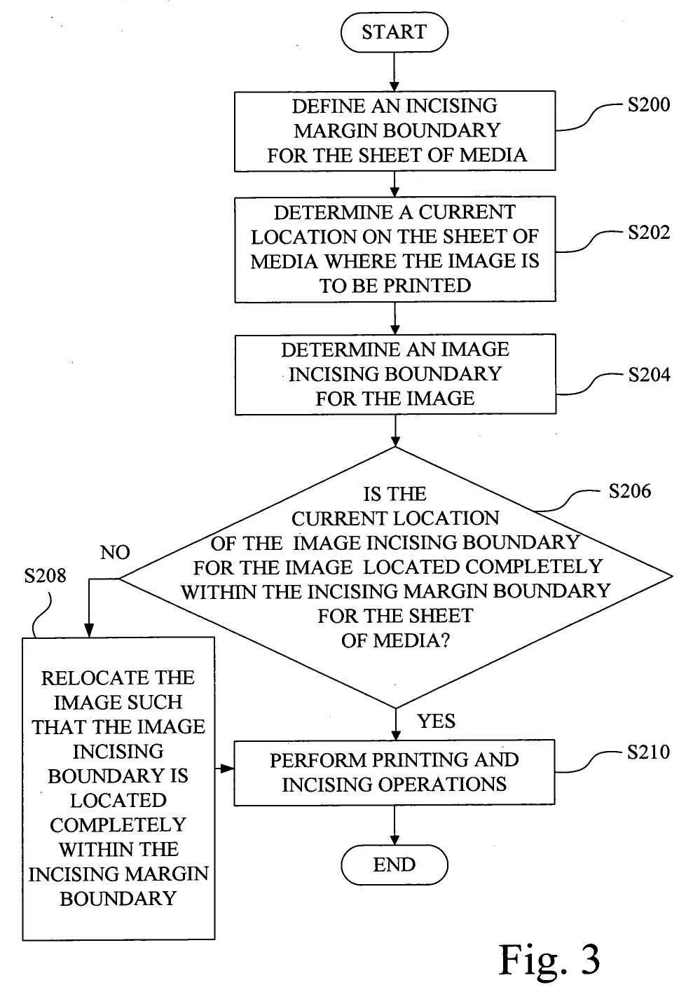

FIG. 3 is a flowchart of an exemplary method, in accordance with the present invention. The method of FIG. 3 may be performed, for example, by imaging apparatus 12 via controller 18 executing program instructions to perform various acts, and to control the operation of printing unit 22 and incising unit 24.

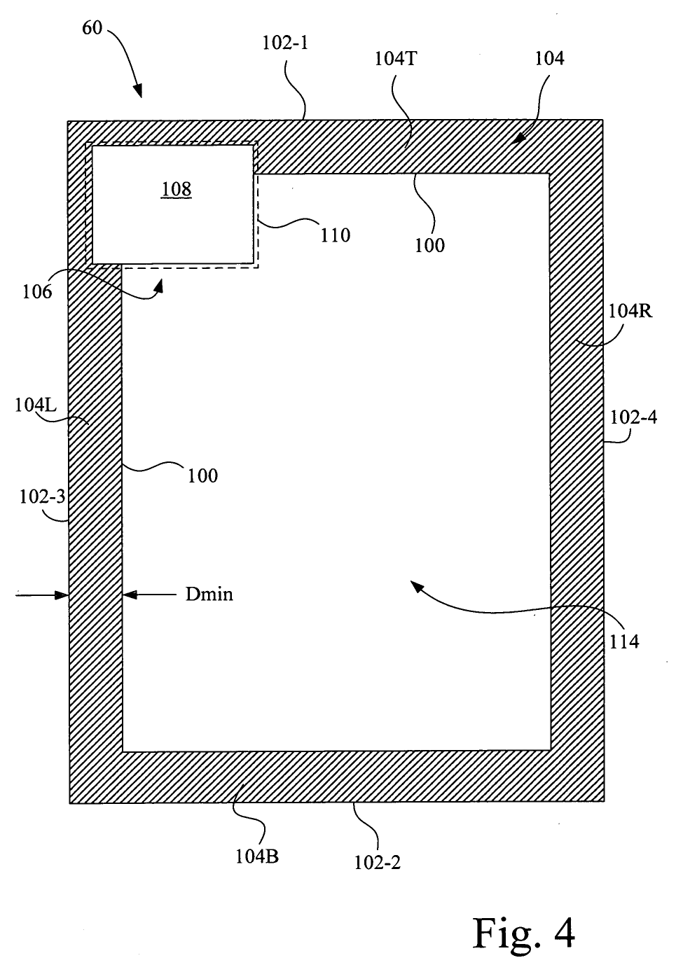

At step S200, referring to FIG. 4, an incising margin boundary 100 is defined for the sheet of media, such as the sheet of media 60. The incising margin boundary 100 defines a minimum distance Dmin from at least one of the plurality of edges 102-1, 102-2, 102-3 and 102-4 of the sheet of media 60 that an incising may be made. In the example of FIG. 4, the incising margins 104 defined by incising margin boundary 100 are shown with cross-hatching. In this example, the top incising margin 104T, the bottom incising margin 104B, the left incising margin 104L and the right incising margin 104R are substantially equal, and the incising margin boundary 100 defines the minimum distance Dmin from each of the plurality of edges 102-1, 102-2, 102-3 and 102-4. However, those skilled in the art will recognize that this need not be the case. In other words, some or all of the top incising margin 104T, the bottom incising margin 104B, the left incising margin 104L and the right incising margin 104R may have a different value for the minimum distance Dmin.

At step S202, a current location 106 with respect to the sheet of media 60 where an image 108 is to be printed is determined. In the example of FIG. 4, image 108 is shown as a rectangular object. However, those skilled in the art will recognize that image 108 may be one or more objects, and have any shape, regular or irregular.

At step S204, an image incising boundary 110 for image 108 is determined. Image incising boundary 110 may be, for example, defined to be some predetermined distance from image 108. Alternatively, image incising boundary 110 may be selected to be on the edge of image 108, or in the interior of image 108, if desired.

At step S206, it is determined whether image incising boundary 110 for image 108 at the current location 106 is located completely within incising margin boundary 100 for the sheet of media 60. As used in the context of the present invention, image incising boundary 110 will be considered to be completely within incising margin boundary 100 even if a portion of the image incising boundary 110 is coincident with incising margin boundary 100.

In the example of FIG. 4, the determination is NO. In other words, a portion of image incising boundary 110 lies within the top incising margin 104T and the left incising margin 104L. If image incising boundary 110 is not located completely within the incising margin boundary 100, then the process proceeds to step S208.

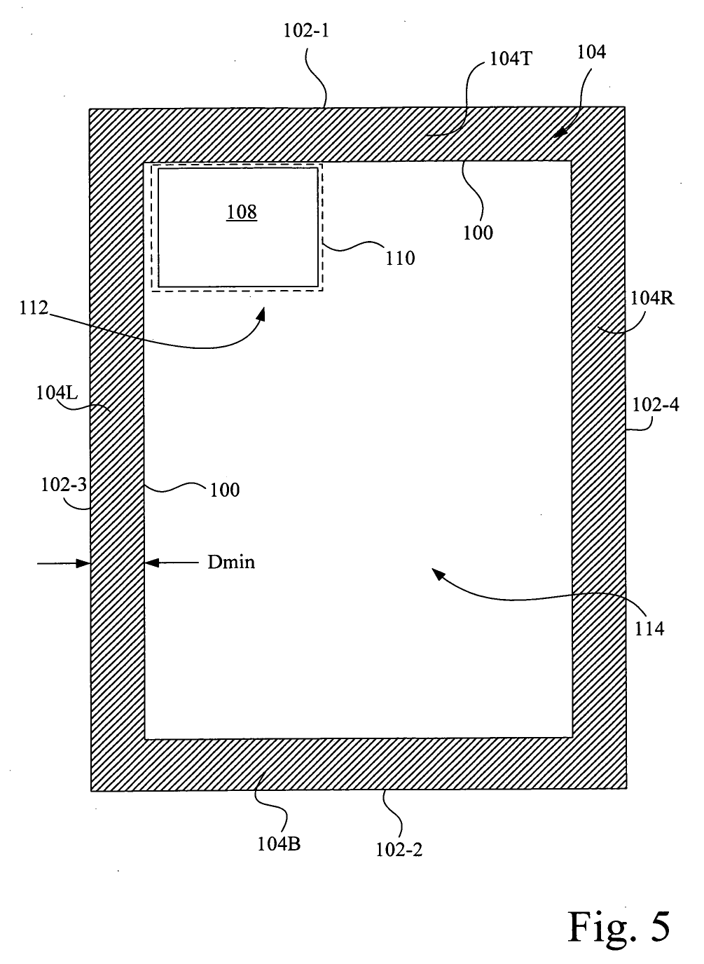

At step S208, image 108 is relocated to a new location 112, as shown in FIG. 5, such that image incising boundary 110 is located completely within the incising margin boundary 100, and in this example, completely in an interior region 114 bounded by incising margin boundary 100.

After step S208, or if the result of the determination at step S206 is YES, then the process proceeds to step S210.

At step S210, image printing and incising operations are performed by printing unit 22 and incising unit 24, respectively. In one embodiment, the operations of printing and incising are performed as interleaved operations. In other words, printing occurs prior to the completion of incising, and vice-versa. In another embodiment, for example, the operations of printing and incising may be performed sequentially, in either order.

Incising unit 24 may perform the incising by forming spaced perforations in the sheet of media 60, such as by using perforation device 74, e.g., a perforation needle, at a predefined perforation density. In another implementation, incising unit 24 may perform the incising by forming a continuous cut, such as by using non-spaced perforations or a rotary or blade cutter. Further, it is contemplated that the incising may be performed using a combination of spaced perforations and continuous cuts.

While incising is not permitted within incising margin 104, printing may occur within incising margin 104. Accordingly, the image need not be completely within incising margin boundary 100, so long as no portion of the image incising boundary 110 remains outside incising margin boundary 100.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for incising a sheet of media having a plurality of edges, comprising:
defining an incising margin boundary for said sheet of media, said incising margin boundary defining a minimum distance from each of at least one of said plurality of edges of said sheet of media that an incising may be made;
determining a current location with respect to said sheet of media where an image is to be printed;
determining an image incising boundary for said image;
determining whether said image incising boundary for said image at said current location is located completely within said incising margin boundary for said sheet of media; and
if said image incising boundary is not located completely within said incising margin boundary, then relocating said image such that said image incising boundary is located completely within said incising margin boundary.

2. The method of claim 1, wherein said defining said incising margin boundary for said sheet of media defines a minimum distance from at least two of said plurality of edges of said sheet of media that said incising may be made.

3. The method of claim 1, wherein said defining said incising margin boundary for said sheet of media defines a minimum distance from each of said plurality of edges of said sheet of media that said incising may be made.

4. The method of claim 1, wherein a printable area of said sheet of media sheet extends outside said incising margin boundary.

5. The method of claim 1, further comprising performing a printing operation and an incising operation with respect to said image.

6. The method of claim 5, wherein the operations of printing and incising are performed as interleaved operations.

7. The method of claim 5, wherein the operations of printing and incising are performed sequentially.

8. The method of claim 5, wherein said incising operation is performed by forming spaced perforations in said sheet of media along said image incising boundary.

9. The method of claim 5, wherein said incising operation is performed by forming a continuous cut along said image incising boundary.

10. An imaging apparatus, comprising:
a printing unit for performing printing operations;
an incising unit for performing incising operations; and
a controller communicatively coupled to said printing unit and said incising unit, said controller executing program instructions to perform the acts of:
defining an incising margin boundary for said sheet of media, said incising margin boundary defining a minimum distance from each of at least one of said plurality of edges of said sheet of media that an incising may be made;
determining a current location with respect to said sheet of media where an image is to be printed;
determining an image incising boundary for said image;
determining whether said image incising boundary for said image at said current location is located completely within said incising margin boundary for said sheet of media; and
if said image incising boundary is not located completely within said incising margin boundary, then relocating said image such that said image incising boundary is located completely within said incising margin boundary.

11. The imaging apparatus of claim 10, wherein said incising margin boundary for said sheet of media defines a minimum distance from at least two of said plurality of edges of said sheet of media that said incising may be made.

12. The imaging apparatus of claim 10, wherein said incising margin boundary for said sheet of media defines a minimum distance from each of said plurality of edges of said sheet of media that said incising may be made.

13. The imaging apparatus of claim 10, wherein a printable area of said sheet of media sheet extends outside said incising margin boundary.

14. The imaging apparatus of claim 10, wherein said controller executes program instructions to control said printing unit and said incising unit to perform a printing operation and an incising operation with respect to said image.

15. The imaging apparatus of claim 14, wherein the operations of printing and incising are performed as interleaved operations.

16. The imaging apparatus of claim 14, wherein the operations of printing and incising are performed sequentially.

17. The imaging apparatus of claim 14, wherein said incising unit performs said incising operation by forming spaced perforations in said sheet of media along said image incising boundary.

18. The imaging apparatus of claim 14, wherein said incising unit performs said incising operation by forming a continuous cut along said image incising boundary.
